(19) United States
(12) Patent Application Publication
(10) Pub. No.: US 2006/0118537 A1
(43) Pub. Date: Jun. 8, 2006

(54) Copper-plated wires for gas-shielded arc welding

(75) Inventors: Yong Chul Kim, Changwon (KR); Hwan Cheol Bang, Changwon (KR)

Correspondence Address: SQUIRE, SANDERS & DEMPSEY L.L.P, 600 HANSEN WAY, PALO ALTO, CA, 94304-1043, US

(73) Assignee: KISWEL LTD.

(21) Appl. No.: 11/292,514

(22) Filed: Dec. 2, 2005

(30) Foreign Application Priority Data
Dec. 3, 2004 (KR) 10-2004-0101309

(51) Int. Cl. B23K 35/02

(52) U.S. Cl. 219/145.1

(57) ABSTRACT

Disclosed herein is a copper-plated wire for gas-shielded arc welding. In the copper-plated wire, wire surface, from which a plated layer is removed, has a prominence and depression ( [symbol] [symbol] ) shape on a circumference of a cross section in a direction of 90 degrees to a length of the wire, such that a ratio (dr/di) of an actual circular arcs length (dr) to an apparent circular arcs length (di) is in the range of 1.015-1.815. The wire has the prominence and depression ( [symbol] [symbol] ) shape in a longitudinal direction of wire, such that a ratio (lr/li) of an actual measured length (lr) to an apparent measured length (li) is in the range of 1.015-1.515. The wire has improved surface characteristics of wire, so that adhesion between a substrate wire and a plated layer becomes excellent during copper plating on the wire surface, thereby remarkably enhancing the rust resistance and the feedability of wire in comparison to the conventional technology.

### BACKGROUND OF THE INVENTION

1. Field of the Invention

The present invention generally relates to copper-plated wires for gas-shielded arc welding, and, more particular, to copper-plated wires for gas-shielded arc welding having stable feedability and excellent rust resistance even after keeping long time, as wire used in a semi-automatic welding or robot welding process and the like.

2. Description of the Related Art

Recently, with the development of automated welding, application of wires for gas-shielded arc welding has rapidly increased, and particularly the wires for gas-shielded arc have been widely employed in the iron frame, automobile, shipbuilding, building industry, and the like. As such, wires for gas-shielded arc consumed as large quantities are generally plated(copper-plated) on their surface, in order to ensure properties such as conductivity, feedability, and rust resistance etc required commercially for wire.

Japanese Patent Laid-open publication Sho 58-184095 and Hei 9-323191 as prior arts for ensuring feedability of wire disclose for using a powder type coating agent such as MoS₂, graphite, titanium oxide, etc. Japanese Patent Laid-open publication Hei 8-155671 discloses a technique for applying vegetable oil having a lower coefficient of friction and slight change on surface thereof. Also Japanese Patent Laid-open publication Hei 8-257788, Hei 10-58183, Hei 10-193175, Nos. 2002-239779, 2002-283096 and 2003-225794 disclose for a mixture of a powder type coating agent such as MoS₂, WS₂, graphite and an oil type coating agent.

The powder type coating agent only or the mixture of the powder type coating agent and the oil type coating agent can have the effect of enhanced feedability. However, in case of applying said coating agents, in particular, the powder type coating agent only, on the surface of the wire, the coating agents can act as a forming mechanism of local battery, causing the wire to rust. Meanwhile the oil type coating agent is more efficient to enhance the rust resistance of the wire than the powder type coating agent, but have still problem as having less advantageous for feedability.

Japanese Patent Laid-open publication Hei 8-103885 and Hei 8-103886 as prior arts for enhancing the rust resistance of a copper-free wire disclose a technique of controlling measurement value of a contact electric resistance in a predetermined range. In addition, Japanese Patent Laid-open publication Hei 9-136186 discloses a technique of controlling a potential value of natural digestion in a predetermined range. These conventional techniques propose means for maintaining a substrate surface of the wire as stable state considering that the substrate surface of copper-free wire is directly exposed to air.

Copper plating on the surface of the wire purposes to enhance corrosion resistance on the wire surface by excellent corrosion resistance as well as enhance conductivity and feedability of the wire. When plating surface of the wire surface with copper, rust resistance of the wire can be enhanced, but it is also possible for the plated wire to be subjected to corrosion. It has been believed that a corrosion mechanism of the plated wire is caused by galvanic corrosion occurred by being exposed a part of the wire substrate, or local battery occurred on the copper plated layer by being unevenly formed on the substrate surface of the wire (Japanese Patent Laid-open publication Hei 9-136186 and Hei 8-103885). Considering such corrosion mechanism of the plated wire, it can be concluded that a plated layer having excellent adhesion between the wire substrate and the plated layer, is very important in terms of rust resistance.

In order to obtain a wire having good adhesion between the wire substrate and the plated layer, the wire must have a flat and even surface. That is why lubricant supplied for drawing process cannot be completely degreased during a degreasing process prior to a plating process when the wire substrate has an uneven or severely roughened surface, and then the plated layer formed on such a surface of the wire substrate becomes weak. In particular, when the surface of the wire substrate has a bottleneck or cave shape, the problem as described above becomes serious.

Thus, with only copper plating of wire, there is a limit to ensure rust resistance thereof. There is still a limit to ensure rust resistance even with controlling of a thickness and attached amount etc of the copper plate as in the prior arts. This is why the plated layer of wire can enhance rust resistance thereof, and thus the unevenly plated layer, that is, poor adhesion between the wire substrate and the plated layer, makes it difficult to ensure the rust resistance.

As described above, the copper plating is performed for the purpose of enhancing the feedability, the rust resistance, and the like of the wire in the plated wire for gas-shielded arc welding, there is still a need to provide a wire with excellent rust resistance caused by excellent adhesion between the wire substrate and the plated layer together with excellent feedability.

### SUMMARY OF THE INVENTION

The present invention has been made to solve the above problems, and it is an object of the present invention to provide a copper-plated wire for gas-shielded arc welding, with excellent rust resistance caused by excellent adhesion between a wire substrate and a plated layer together with excellent feedability.

In accordance with one aspect of the present invention, the above objects can be accomplished by the provision of a copper-plated wire for gas-shielded arc welding, wherein a wire surface has a prominence and depression ( [symbol] [symbol] ) shape on a circumference of a cross section in a direction of 90 degrees to a length of the wire, such that a ratio (dr/di) of an actual circular arcs length (dr) to an apparent circular arcs length (di) is in the range of 1.015˜1.815.

The wire may have the prominence and depression ( [symbol] [symbol] ) shape in a longitudinal direction of wire, such that a ratio (lr/li) of an actual measured length (lr) to an apparent measured length (li) is in the range of 1.015˜1.515.

The wire may apply coating agent of 0.03˜0.50 g per wire 1 kg on the surface of the wire, wherein the coating agent may comprise at least one selected from the group consisting of liquid animal oil, vegetable oil, mineral oil, and synthetic oil.

### BRIEF DESCRIPTION OF THE DRAWINGS

The foregoing and other objects and features of the present invention will be more clearly understood from the following detailed description taken in conjunction with the accompanying drawings, in which:

FIG. 1 is a scanning electron microscope (SEM) micrograph showing an image for measuring length of a chord for circulation an apparent circular arcs length;

FIG. 2 is a view depicting the relationship between a length of chord, a radius (r) of the wire, an inner angle (θ) of a circle, and an apparent circular arcs length (di);

FIG. 3 is a SEM micrograph showing an image for measuring an apparent measured length;

FIGS. 4 and 5 are SEM micrographs showing each image before and after measuring an actual circular arcs length using an image analysis system; and

FIGS. 6 and 7 are SEM micrographs showing each image before and after measuring an actual measured length using the image analysis system.

### DESCRIPTION OF THE PREFERRED EMBODIMENTS

Preferred embodiments will now be described in detail with reference to the accompanying drawings.

Since a plated wire and a copper-free wire are manufactured as different processes, a wire from which a copper plated layer is removed has a different shape from that of the copper-free wire. The copper-plated wire is manufactured by procedures of acid pickling-primary drawing-degreasing-plating-secondary drawing or procedures of acid pickling-primary drawing-heat treatment for removing stress-acid picking-secondary drawing-degreasing-plating-tertiary drawing (including skin pass). At this time, since the plated layer is directly worked (in case of the copper-free wire, a substrate layer thereof is directly worked) during the secondary drawing or the tertiary drawing(including skin pass) after plating process, the surface shape of the final wire, from which a copper-plated layer is removed, has very few worked surfaces (a flat shaped-surface formed by processing of die in drawing) unlike the copper-free wire, when viewing the surface of a cross section in a direction of 90 degrees to a length of the wire and in a longitudinal direction, so that the wire has a relatively uneven surface. In addition, the copper-free wire has depressions ( [symbol] ) shape in a negative direction (towards a center of the wire) based on the worked surface as standard, whereas the copper-plated wire has a prominence and depression ( [symbol] [symbol] ) as a shape of surface removed the plated layer from the wire.

When the wire substrate has an uneven or severely roughened surface, in particular the wire substrate is formed with a bottleneck or cave shape on the surface due to unevenness, a bridge phenomenon occurs during a plating process, in which the plated layer forms a bridge. In addition, when the wire substrate has the bottleneck or cave shape on the surface, residues of lubricant or impurities are trapped in the bottleneck or cave, thereby preventing a normal plated layer from being formed on the wire substrate, and even if the normal plated layer is partially formed on the surface of the wire substrate, the bridge phenomenon inevitable occurs as described above, in which the plated layer is initially formed at an inlet of the bottleneck or the cave shape instead of an interior of the bottleneck or the cave shape.

Portions occurred by the bridge phenomenon becomes a site where a local battery is formed, thereby reducing rust resistance due to corrosion at this portion, and causing Cu flakes during feeding of the wire. Thus, it is desirable that the wire substrate does not have any bottleneck or cave shaped surface, if possible.

The inventors of the present invention have performed various experiments to develop a surface layer of a wire having excellent in adhesion between a plated layer and a wire substrate in order to enhance rust resistance and feedability. As a result, the inventors have found that the surface of the wire substrate (surface of a final wire from which a plated layer is removed) have excellent rust resistance and feedability by controlling a ratio (dr/di) of an actual circular arcs length (dr) to an apparent circular arcs length (di), and a ratio (lr/li) of an actual measured length (lr) to an apparent measured length (li) as surface factors of the wire in a circumferential direction and a longitudinal direction in a predetermined range.

Hereinafter, the ratio (dr/di) of the actual circular arcs length (dr) to the apparent circular arcs length (di) means physically circumferential uniformity on the surface of the wire substrate to be formed with the plated layer, while the ratio (lr/li) of the actual measured length (lr) to the apparent measured length (li) means physically longitudinal uniformity on the surface of the wire substrate to be formed with the plated layer.

The experiments performed by the inventors have been shown that the ratio (dr/di) of the actual circular arcs length (dr) to the apparent circular arcs length (di) as one of the surface factor is in the range of 1.015˜1.815, in order to have excellent adhesion between the wire substrate and the plated layer. Here, the term “apparent circular arcs length (di)” means a value obtained by theoretically calculating a length of arc corresponding to a measured area using an actual diameter of the wire on an image magnified 1,000 times by the SEM for a cross section in the direction of 90 degrees to the length of the wire, and a calculating method thereof will be described hereinafter. In addition, the term “actual circular arcs length (dr)” means a value obtained by measuring an actual circular arcs length (that is, the length of arc including length of circumferences of essential parts existed on the wire surface) of arc corresponding to the measured area using an image analysis system on an image magnified 1,000 times by the SEM for the cross section in the direction of 90 degrees to the length of the wire.

It is impossible in practice to achieve a condition wherein the ratio (dr/di) of the actual circular arcs length to the apparent circular arcs length is less than 1.015, and, even if this condition were to be achieved, obtained wire would be economically unfeasible. If the ratio (dr/di) of the actual circular arcs length to the apparent circular arcs length exceeds 1.815, the wire substrate has an uneven or severely roughened surface. Therefore, residues of lubricant by drawing cannot be completely degreased during a degreasing process prior to a plating process. Plated layer formed on surface of wire degreased incompletely becomes weak. When the ratio (dr/di) of the actual circular arcs length to the apparent circular arcs length is in the range of 1.015˜1.815, the wire has a flat and even surface on a cross section of the wire.

The experiment performed by the inventors have been also shown that, when the ratio (dr/di) of the actual circular arcs length (dr) to the apparent circular arcs length (di) is in the range according to the present invention while the ratio (lr/li) of the actual measured length (lr) to the apparent measured length (li) as another surface factor, is in the range of 1.015˜1.515, the adhesion between the wire substrate and the plated layer becomes further excellent. Here, the term “apparent measured length (li)” means a value obtained by measuring an apparent length of the wire corresponding to a measured area using the image analysis system on an image magnified 1,000 times by the SEM for a cross section in the longitudinal direction, and the term “actual measured length (lr)” means a value obtained by measuring an actual length (that is, the range including length of circumferences of essential parts existed on the wire surface) of the wire corresponding to the measured area using the image analysis system on an image magnified 1,000 times by the SEM for the cross section in the longitudinal direction of the wire.

It is impossible in practice to achieve a condition wherein the ratio (lr/li) of the actual measured length (lr) to the apparent measured length (li) is less than 1.015, and, even if this condition were to be achieved, such a wire would be economically unfeasible. If the ratio (lr/li) of the actual measured length to the apparent measured length exceeds 1.515, the wire substrate has an uneven or severely roughened surface in the longitudinal direction of wire. In particular, due to scratch created in surface during hot rolling of the rod or due to non-metallic inclusions existed in the material, surface of wire can be created surface scars or burs etc. during drawing. In this case, the ratio (lr/li) is deviated from suitable range of the invention(1.015˜1.515). When the ratio (lr/li) is in the range of 1.015˜1.515, the wire has a flat surface in the longitudinal direction of wire, and thus have enhanced adhesion between the wire substrate and the copper plated layer, which can prevent hindrance of feeding due to clogging of Cu flakes in a feeding cable and a contact tip during welding process.

In addition, according to the present invention, a coating agent of 0.03˜0.50 g per 1 kg of wire is applied on the wire surface to ensure lubrication property.

If the amount of coating agent is less than 0.03 g, sufficient lubrication property cannot be ensured due to the excessively low amount of the coating agent, thus deteriorating the feedability. On the contrary, if the amount of coating agent is more than 0.50 g, feedability is deteriorated due to slip in a feeder section during welding process.

The coating agent preferably comprises at least one selected from the group consisting of liquid animal oil, vegetable oil, mineral oil, and synthetic oil.

Coating agent of the present invention employs an oil type coating agent instead of powder type coating agents unlike the conventional techniques. That is why the powder type or mixed coating agent applied to the wire surface has/have effect in terms of feedability, but it also acts as a formation site of a local battery as described above upon being applied to coating agents to the surface of wire, and thus creates rust.

A method for forming a wire plated for gas-shielded welding having suitable ratios of the surface factors will be described hereinafter.

In order to secure the ratios of the surface factors in suitable range of the invention, first, the surface roughness before drawing, that is, the roughness of an original rod subjected to drawing process must be adjusted to 0.45 μm or less (Ra standard). This can be obtained by polishing process after mechanical de-scaling or acid pickling using hydrochloric acid, sulfuric acid, and the like.

Next, there have need of appropriate combination between a drawing method and a drawing rate of process prior to plating. When drawing process is performed in order of acid pickling-primary drawing-degreasing-plating-secondary drawing, continuous (in-line) primary drawing such as all dry drawing (hereinafter, “DD”), drawing by all cassette roller die (hereinafter, “CRD”), and CRD+DD combination will be performed. Alternatively, when process is performed in order of acid pickling-primary drawing-heat treatment for stress relief-acid pickling-secondary drawing-degreasing-plating-tertiary drawing (including skin pass), the primary and secondary drawing such as two stage drawing of DD (primary drawing)-skin pass (hereinafter, “SP”) (secondary drawing), DD (primary drawing)-wet drawing (hereinafter, “WD”) (secondary drawing), CRD (primary drawing)-SP (secondary drawing) or CRD (primary drawing)-WD (secondary drawing) will be performed.

Drawing rate for continuous (in-line) primary drawing process must be controlled to 1,500 m/min or less, and drawing rate for two-stage drawing process must be controlled such that the higher the primary drawing rate, the lower the secondary drawing rate.

Lastly, the surface roughness of interim wire passed to the primary drawing or the primary and secondary drawing must be in the range of 0.30 μm or less (Ra standard) by appropriately adjusting the roughness of the original rod, the drawing method, and the drawing rate.

An example of the invention will be described as follows.

Table 1 shows the surface roughness of the interim wire obtained according to roughness, drawing methods, and drawing rates of original rod. When drawing the rod, hole die was used except for the CRD of drawing method. In order to provide surface roughness of the interim wire in the range of 0.30 μm or less (Ra standard), the following conditions were required. That is, the surface roughness of the original rod had to be adjusted to 0.45 μm or less (Ra standard). Additionally, the primary drawing rate for continuous (in-line) all DD, the CRD, or the combination thereof was controlled to 1,500 m/min or less, and for two-stage drawing, if the primary drawing rate was in the range of 1,000˜1,500 m/min, the secondary drawing rate was 400 m/min or less, and if the primary drawing rate was in the range of 500˜1,000, m/min, the secondary drawing rate was 600 m/min or less. That is, the higher the primary drawing rate, the lower the secondary drawing rate. As such, there have need of suitable combination for the roughness, drawing methods, and drawing rates of original rod. In each case, a method of bipolar electrolytic degreasing+cathode electrolytic acid pickling or a method of anode electrolytic degreasing+anode electrolytic acid pickling was performed as the degreasing process prior to the plating process.

TABLE 1

| | Roughness before | | Drawing rate(m/min) | | Roughness after |
|---|---|---|---|---|---|
| Sample | drawing | | Primary | Secondary | drawing |
| No. | (μm) | Drawing method | drawing | drawing | (μm) |
| CE 1 | 0.63 | DD, | >1500 | — | 0.39 |
| CE 2 | 0.55 | CRD, | >1500 | — | 0.51 |
| CE 3 | 0.49 | CRD + DD | >1500 | — | 0.45 |
| CE 4 | 0.46 | (primary drawing | >1500 | — | 0.34 |
| IE 1 | 0.41 | method of acid | >1000^{˜}1500 | — | 0.29 |
| IE 2 | 0.45 | pickling-primary | >1000^{˜}1500 | — | 0.26 |
| CE 5 | 0.39 | drawing- | >1000^{˜}1500 | — | 0.48 |
| CE 6 | 0.35 | degreasing- | >1000^{˜}1500 | — | 0.29 |
| CE 7 | 0.45 | plating- | >1000^{˜}1500 | — | 0.42 |
| IE 3 | 0.32 | secondary | 500^{˜}1000 | — | 0.21 |
| IE 4 | 0.35 | drawing) | 500^{˜}1000 | — | 0.25 |
| IE 5 | 0.33 | | 500^{˜}1000 | — | 0.22 |
| IE 6 | 0.34 | | 500^{˜}1000 | — | 0.24 |
| IE 7 | 0.44 | | 500^{˜}1000 | — | 0.28 |
| IE 8 | 0.40 | | <500 | — | 0.24 |
| CE 8 | 0.44 | | <500 | — | 0.25 |
| IE 9 | 0.37 | | <500 | — | 0.20 |
| IE 10 | 0.29 | | <500 | — | 0.15 |
| IE 11 | 0.42 | | <500 | — | 0.23 |

Note:
CE = comparative example, IE = Inventive example, DD = all dry drawing,CRD = all cassette
roller-die drawing, PD: primary drawing, SD: Secondary drawing

| | | | | | |
|---|---|---|---|---|---|
| CE 9 | 0.43 | DD(PD) + SP(SD), | >1500 | >600 | 0.40 |
| IE 12 | 0.41 | DD(PD) + WD(SD), | >1500 | >600 | 0.25 |
| CE 10 | 0.40 | CRD(PD) + SP(SD), | >1500 | 400^{˜}600 | 0.43 |
| CE 11 | 0.38 | CRD(PD) + WD(SD) | >1500 | 200^{˜}400 | 0.29 |
| IE 13 | 0.38 | (drawing methods | >1500 | <200 | 0.24 |
| CE 12 | 0.45 | of primary and | >1500 | <200 | 0.30 |
| CE 13 | 0.42 | secondary drawing | >1000^{˜}1500 | >600 | 0.41 |
| CE 14 | 0.41 | of acid pickling- | >1000^{˜}1500 | 400^{˜}600 | 0.38 |
| IE 14 | 0.35 | primary drawing- | >1000^{˜}1500 | 200^{˜}400 | 0.22 |
| IE 15 | 0.37 | heat treatment for | >1000^{˜}1500 | 200^{˜}400 | 0.20 |
| IE 16 | 0.38 | stress relief-acid | >1000^{˜}1500 | <200 | 0.15 |
| IE 17 | 0.34 | pickling-secondary | >1000^{˜}1500 | <200 | 0.22 |
| IE 18 | 0.32 | drawing- | >1000^{˜}1500 | <200 | 0.24 |
| CE 15 | 0.51 | degreasing-plating- | 500^{˜}1000 | >600 | 0.35 |
| IE 19 | 0.39 | tertiary drawing) | 500^{˜}1000 | 400^{˜}600 | 0.21 |
| IE 20 | 0.44 | | 500^{˜}1000 | 400^{˜}600 | 0.22 |
| IE 21 | 0.33 | | 500^{˜}1000 | 200^{˜}400 | 0.24 |
| IE 22 | 0.39 | | 500^{˜}1000 | 200^{˜}400 | 0.23 |
| IE 23 | 0.34 | | 500^{˜}1000 | <200 | 0.19 |
| IE 24 | 0.28 | | 500^{˜}1000 | <200 | 0.16 |
| CE 16 | 0.42 | | <500 | >600 | 0.27 |
| CE 17 | 0.47 | | <500 | 400^{˜}600 | 0.25 |
| CE 18 | 0.46 | | <500 | 200^{˜}400 | 0.29 |
| IE 25 | 0.30 | | <500 | 200^{˜}400 | 0.24 |

Note:
CE = comparative example, IE = Inventive example, DD = all dry drawing, CRD = all cassette
roller-die drawing, SP: skin pass, WD: wet drawing, PD: primary drawing, SD: Secondary drawing

Table 2 shows the results of measurement for a ratio (dr/di) of an actual circular arcs length (dr) to an apparent circular arcs length (di), a ratio (lr/li) of an actual measured length (lr) to an apparent measured length (li), an amount of coating agent used for drawing, rust resistance, and feedability for respective wire samples obtained by Table 1.

TABLE 2

| | | | Coating agent | Rust | |
|---|---|---|---|---|---|
| Sample No. | dr/di | lr/li | (g/W · Kg) | resistance | Feedability |
| CE 1 | 1.829 | 1.536 | 0.33 | X | X |
| CE 2 | 1.836 | 1.534 | 0.12 | X | X |
| CE 3 | 1.845 | 1.588 | 0.03 | X | X |
| CE 4 | 1.819 | 1.528 | 0.24 | X | X |
| IE 1 | 1.812 | 1.503 | 0.42 | ◯ | ◯ |
| IE 2 | 1.793 | 1.514 | 0.44 | ◯ | ◯ |
| CE 5 | 1.841 | 1.535 | 0.02 | X | X |
| CE 6 | 1.798 | 1.516 | 0.35 | Δ | Δ |
| CE 7 | 1.833 | 1.521 | 0.01 | X | X |
| IE 3 | 1.815 | 1.509 | 0.48 | ◯ | ◯ |
| IE 4 | 1.779 | 1.482 | 0.50 | ◯ | ◯ |
| IE 5 | 1.767 | 1.371 | 0.45 | ◯ | ◯ |
| IE 6 | 1.763 | 1.415 | 0.37 | ◯ | ◯ |
| IE 7 | 1.785 | 1.515 | 0.41 | ◯ | ◯ |
| IE 8 | 1.575 | 1.256 | 0.22 | ◯ | ◯ |
| CE 8 | 1.305 | 1.523 | 0.32 | ◯ | Δ |
| IE 9 | 1.625 | 1.311 | 0.15 | ◯ | ◯ |
| IE 10 | 1.521 | 1.227 | 0.09 | ◯ | ◯ |
| IE 11 | 1.774 | 1.345 | 0.36 | ◯ | ◯ |
| CE 9 | 1.858 | 1.539 | 0.21 | X | X |
| IE 12 | 1.672 | 1.505 | 0.43 | ◯ | ◯ |
| CE 10 | 1.824 | 1.616 | 0.35 | X | X |
| CE 11 | 1.778 | 1.518 | 0.41 | Δ | Δ |
| IE 13 | 1.459 | 1.448 | 0.31 | ◯ | ◯ |
| CE 12 | 1.725 | 1.512 | 0.72 | ◯ | Δ |
| CE 13 | 1.902 | 1.614 | 0.33 | X | X |
| CE 14 | 1.834 | 1.517 | 0.34 | X | X |
| IE 14 | 1.181 | 1.117 | 0.47 | ◯ | ◯ |
| IE 15 | 1.414 | 1.232 | 0.41 | ◯ | ◯ |
| IE 16 | 1.023 | 1.092 | 0.03 | ◯ | ◯ |
| IE 17 | 1.310 | 1.189 | 0.11 | ◯ | ◯ |
| IE 18 | 1.211 | 1.178 | 0.24 | ◯ | ◯ |
| CE 15 | 1.818 | 1.486 | 0.45 | X | X |
| IE 19 | 1.015 | 1.016 | 0.34 | ◯ | ◯ |
| IE 20 | 1.025 | 1.019 | 0.21 | ◯ | ◯ |
| IE 21 | 1.027 | 1.021 | 0.05 | ◯ | ◯ |
| IE 22 | 1.382 | 1.228 | 0.28 | ◯ | ◯ |
| IE 23 | 1.021 | 1.119 | 0.42 | ◯ | ◯ |
| IE 24 | 1.261 | 1.135 | 0.18 | ◯ | ◯ |
| CE 16 | 1.619 | 1.504 | 0.54 | ◯ | Δ |
| CE 17 | 1.816 | 1.251 | 0.38 | X | X |
| CE 18 | 1.821 | 1.311 | 0.46 | X | X |
| IE 25 | 1.017 | 1.015 | 0.07 | ◯ | ◯ |

Note:
CE = comparative example,
IE = Inventive example,

The ratio (dr/di) of the actual circular arcs length (dr) to the apparent circular arcs length (di), and the ratio (lr/li) of the actual measured length (lr) to the apparent measured length (li) were calculated as follows.

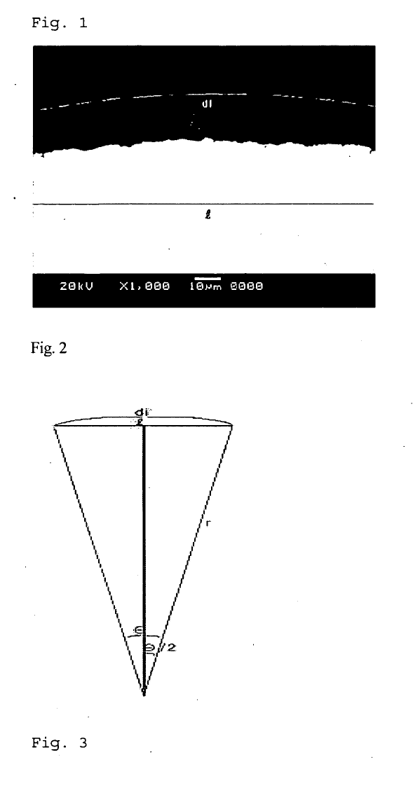

First, the apparent circular arcs length (di) of the wire was calculated as follows. FIG. 1 is an SEM micrograph showing measurement image of a chord for measuring an apparent circular arcs length (di). A length (l) of chord in a measuring section was measured on the SEM micrograph using an image analysis system (Image-pro plus 4.5, Media cybernetics). Actual diameter of the wire measured and then a radius(r) of the wire was obtained. An inner angle θ (radian) of a circle was obtained from a radius and the length (l) of chord at the center of the circle in terms of the trigonometric function as shown in FIG. 2, using the length (l) of chord and radius (r) of the product obtained using image analysis system from FIG. 1. As a result, the apparent length (di) of arc was obtained using the inner angle (θ) was calculated from the equation: Radius (r) of the wire X inner angle (θ) of the circle.

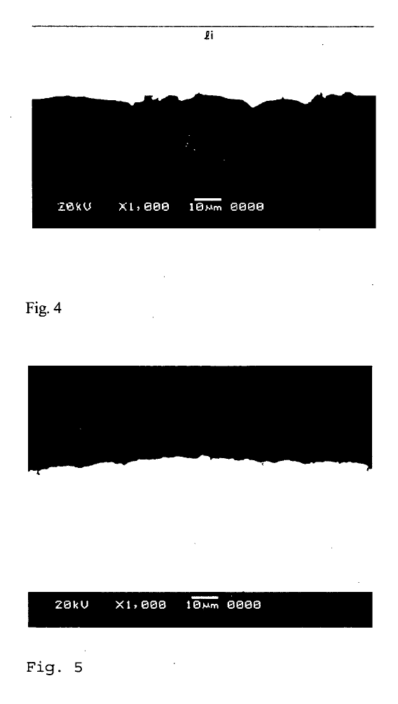

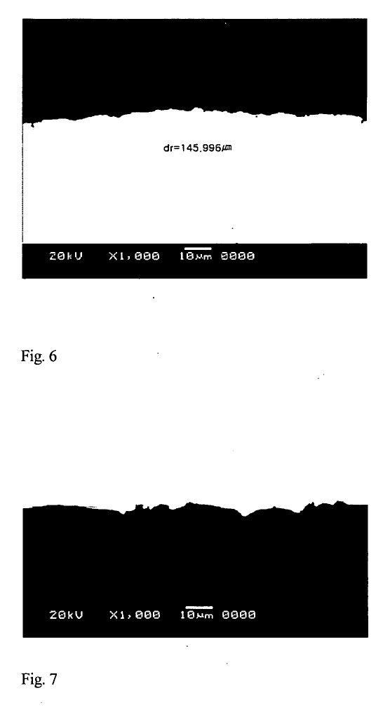

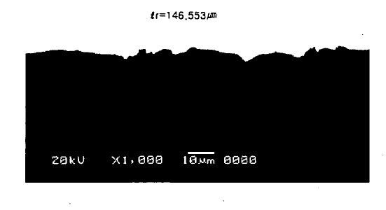

FIG. 3 is an SEM micrograph showing an image for measuring the apparent measured length (li) using the image analysis system. FIGS. 4 and 5 are SEM micrographs showing images before and after measuring an actual circular arcs length (dr) using the image analysis system, respectively, and FIGS. 6 and 7 are SEM micrographs showing images before and after measuring an actual measured length (lr) using the image analysis system, respectively.

Thus, the ratio (dr/di) of the actual circular arcs length (dr) to the apparent circular arcs length (di), and the ratio (lr/li) of the actual measured length (lr) to the apparent measured length (li) could be obtained by using the calculation from Equation as described above, or from value measured by using the image analysis system from actual image.

Actual measurement using the image analysis system was preformed as described below. First, final plating wire were picked, and deposited for 10 minutes in a solution of total 100 ml (NH₄OH (300 cc)+CCl₃COOH (25 g)+distilled water=1000 ml), provided by dissolving NH₄OH (300 cc) and CCl₃COOH (25 g) in distilled water to remove plating layer from the wire, followed by cleaning water and alcohol, and then drying. Then, the wire samples were heated at 400° C. for 2˜3 hours, thereby forming an oxidized coating on the wire surface. Subsequently, each of the wire samples having the oxidized coating thereon was subjected to a mounting and polishing using a thermosetting resin toward a cross section of the wire sample vertical to the length of the wire sample. Finally, the polished horizontal cross section of each wire sample was observed using back scattering electrons of the SEM to observe a surface shape of the cross section of the wire samples, and then the apparent circular arcs length and the actual circular arcs length were measured using the image analysis system to calculate the ratio of dr/di. At this time, the magnification was 1,000 times. In addition, the actual measured length (lr), and the apparent measured length (li) in the longitudinal direction of wire were also measured according to the same method described above.

An amount applied on coating agent was measured according to the following method.
1. Cut wire samples having a length of 6˜8 cm and prepare wire having weight of about 50˜80 g.
2. Place 1,000 ml of CCl₄ as solvent in a beaker.
3. Measure a weight (Wb) before degreasing of prepared wire sample by using 1 g/10,000 scales.
4. Immerse each wire sample into the beaker containing CCl₄, and degrease the coating agent oil for 10 minutes while stirring the wire sample two or three times.
5. Dry the degreased wire sample for 10 minutes within a dry oven, and cool the wire sample to room temperature in a desiccator.
6. Measure a weight (Wa) after degreasing of the dried wire sample by using 1 g/10,000 scales.
7. Calculate the applied amount of the coating agent based on measured values of Wb and Wa according to the following equation: applied amount of coating agent (g/W.kg)={(Wb−Wa)/Wa}×1000

The rust resistance was evaluated according to the salt water spray test (JIS Z 2371) under conditions shown in Table 3.

Test results were evaluated on the basis of a time period when rust is created on the samples on microscopic examination at 50× magnification. When the rust was created after 5 minutes under the condition of Table 3, the rust resistance was given a poor evaluation, which is indicated by an “x” in the table, when the rust was created after 15 minutes under the condition, the rust resistance was given a normal evaluation, which is indicated by a “Δ” in the table, and when the rust was created after 30 minutes under the condition, the rust resistance was given an excellent evaluation, which is indicated by an “O” in the table.

TABLE 3
Conditions of salt water spray test

| | | | |
|---|---|---|---|
| Concentration of | NaCl 5% | Salt water | 5, 15 and 30 |
| salt water | | exposure | (minutes) |
| | | time | |
| Temperature of | 35° C. | Order of | Insert Sample → |
| chamber | | samples | Remove sample and |
| Temperature of | 50° C. | | directly clean with |
| tank | | | alcohol → dry |
| Pressure of salt | 0.15 MPa | | sample → |
| water spray | | | microscopic |
| | | | examination (×50) |

The feedability was evaluated using a new feeding cable having a length of 5 m and wound two times (ring shape) to a diameter of 300 mm under a welding condition of Table 4.

TABLE 4

| Welding conditions for feedability test | | Welding position |
|---|---|---|
| Current(A): 420 | Voltage(V): 44 | Bead on plate, |
| Welding speed(cm/min): 50 | Welding time(sec): — | Zigzag weaving |
| CO₂ Gas 100% | Gas flux (l/min): 20 | |

For feedabillty, when a continuous welding time was 80 sec or less and feeding was not smoothly performed, and thus resulting in failure of welding, the feedability was given a poor evaluation, which is indicated by an “x” in the table, when the continuous welding time is in the range of 80˜100 sec, the feedability was given a normal evaluation, which is indicated by an “Δ” in the table, and when the welding time exceeded 100 sec and it was evaluated that continuous welding was performed, the feedability was given a good evaluation, which is indicated by an “O” in the table.

The wire samples in examples of this invention used 1.2 mm of JIS Z 3312 YGW12 (AWS A5.18 ER70S-6), also JIS YGW 11, 14, 15, 16, 17, 18 and 21 type wires exhibit the same results as that of above JIS Z 3312 YGW12.

As can be appreciated from Table 2, in Comparative examples 1, 2, 3 and 4, the surface roughness (Ra) before drawing exceeded 0.45 μm, and the surface roughness after drawing at high speed also exceeded 0.30 μm, so that both the ratio (dr/di) and the ratio (lr/li) unfit for the range of the present invention. As a result, the samples of the comparative examples were given poor evaluations both rust resistance and feedability, irrespective of an amount of coating agent remaining on each sample within the range of the present invention. In Comparative example 15, the surface roughness (Ra) before drawing exceeded 0.45 μm, and the surface roughness after drawing also exceeded 0.30 μm, in which secondary drawing was performed at a relatively high speed. As a result, the ratio (dr/di) of the sample exceeded the range of the present invention, whereas the ratio (lr/li) and the amount of coating agent were in the range of the present invention, so that the rust resistance and the feedability were given poor evaluations. In Comparative examples 5, 7, 9, 10, 13 and 14, the surface roughness (Ra) before drawing did not exceed 0.45 μm, whereas the surface roughness after drawing exceeded the range of the present invention, so that both the ratio (dr/di) and the ratio (lr/li) unfit for the range of the present invention. As a result, the samples of the comparative examples were given poor evaluations both rust resistance and feedability. In Comparative examples 17 and 18, the surface roughness (Ra) after drawing was in the range of the present invention, whereas the surface roughness (Ra) before drawing exceeded 0.45 μm, so that the ratio (dr/di) unfit for the range of the present invention. As a result, the samples of the comparative examples were given poor evaluations both rust resistance and feedability, even though the ratio (lr/li) and the amount of coating agent were in the range of the present invention. In Comparative examples 6 and 11, since the surface roughness (Ra) before and after drawing were controlled, the ratio (dr/di) was in the range of the present invention, whereas the ratio (lr/li) unfit for the range of the present invention. As a result, the rust resistance was slightly deteriorated, and the feedability was also deteriorated since Cu flakes clogged inside of feeding cable, and the contact tip. In Comparative example 8, since the surface roughness (Ra) before and after drawing was controlled, the ratio (dr/di) was in the range of the present invention, thereby providing excellent rust resistance, whereas the ratio (lr/li) exceeded the range of the present invention, so that the feedability was deteriorated as the Cu flakes clogged inside of feeding cable, and the contact tip. In Comparative examples 12 and 16, since the surface roughness (Ra) before and after drawing was controlled as the ratio (dr/di) and the ratio (lr/li) were in the range of the present invention, thereby providing excellent rust resistance, whereas the amount of coating agent remaining on the wire surface unfit for the range of the invention, so that slip occurred in a feeding section during welding, causing deterioration of the feedability.

Meanwhile, since the samples in all Inventive examples 1˜25 were produced by optimally adjusting surface roughness before and after drawing, drawing methods, and drawing rates in the range of the invention, it was possible for the wire surface from which the plated layer was removed to have a ratio (dr/di) in the range of 1.015˜1.815 and a ratio (lr/li) in the range of 1.015˜1.515. In addition, the wire samples have amounts of coating agent which are adjusted in the range of 0.03˜0.50 g per 1 kg of wire, thereby satisfying both rust resistance and feedability.

As apparent from the description, according to the present invention, the wire for gas-shielded welding has improved surface characteristics, so that adhesion between a substrate wire and a plated layer becomes excellent during copper plating on the wire surface, thereby remarkably enhancing the rust resistance and the feedability in comparison to the conventional technology.

It should be understood that the embodiments and the accompanying drawings have been described for illustrative purposes and the present invention is limited by the following claims. Further, those skilled in the art will appreciate that various modifications, additions and substitutions are allowed without departing from the scope and spirit of the invention as set forth in the accompanying claims.

What is claimed is:

1. A copper-plated wire for gas-shielded arc welding, wherein a wire surface, from which a plated layer is removed, has a prominence and depression ( [symbol] [symbol] ) shape on a circumference of a cross section in a direction of 90 degrees to a length of the wire, such that a ratio (dr/di) of an actual circular arcs length (dr) to an apparent circular arcs length (di) is in the range of 1.015˜1.815.

2. The copper-plated wire as set forth in claim 1, wherein the wire has the prominence and depression ( [symbol] [symbol] ) shape in a longitudinal direction thereof, such that a ratio (lr/li) of an actual measured length (lr) to an apparent measured length (li) is in the range of 1.015˜1.515.

3. The copper-plated wire as set forth in claim 1 or 2, wherein the wire has 0.03˜0.50 g per 1 kg of wire of coating agent applied on the wire surface.

4. The copper-plated wire as set forth in claim 3, wherein the coating agent comprises at least one selected from the group consisting of liquid animal oil, vegetable oil, mineral oil, and synthetic oil.
